(19) United States
(12) Patent Application Publication
(10) Pub. No.: US 2002/0187307 A1
(43) Pub. Date: Dec. 12, 2002

(54) Cleaning sheet for printer cylinders, and method for producing it

(76) Inventors: Makoto Tanaka, Ikuno-ku (JP); Tadao Mohara, Ikuno-ku (JP); Yoshitsugu Hama, Naruto-shi (JP); Toshiaki Sakai, Tokushima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/106,122

(22) Filed: Mar. 27, 2002

(30) Foreign Application Priority Data
Mar. 30, 2001 (JP) 101792/2001

(51) Int. Cl. B32B 1/00; D04H 1/46

(52) U.S. Cl. 428/152; 442/408

(57) ABSTRACT

A cleaning sheet for printer cylinders is produced by three-dimensionally aggregating fibers into a sheet in a wet paper-making process. The cleaning sheet contains thermofusible fibers that serves as binder fibers, and is creped by heating it at a temperature at which the thermofusible binder fibers therein fuse to thereby make the sheet surface have numerous irregularities.

This application is based on application No. 101792 filed in Japan on Mar. 30, 2001, the content of which incorporated hereinto by reference.

### BACKGROUND OF THE INVENTION

The present invention relates to a sheet for cleaning cylinders such as blanket cylinders and impression cylinders of offset printers, in particular to such a cleaning sheet of improved ability to well wipe off ink and paper powder from printer cylinders, leaving few fibers while in service in printers, and relates to a method for producing the cleaning sheet.

An offset printer is a printing system which is based on the essential repulsion of water to ink applied thereto. In the printing process using it, the image formed on a printing plate set in the printer is once transferred onto a blanket, and then onto printing paper pressed against the blanket by the action of an impression cylinder. In this printing process, unfavorable matters such as ink sediment, paper powder and offset inhibitor that consists essentially of corn starch often adhere to and deposit on cylinders such as blanket and impression cylinders, and they come to worsen the quality of prints. Many recent printers are equipped with an automatic cleaning device for removing such deposits. Regarding its mechanism, the cleaning device has a brush roller or rubber roller for scraping off deposits, but most popularly, it has a cleaning sheet of nonwoven fabric for wiping off deposits.

For cleaning cylinders, most popularly used are cleaning sheet of nonwoven fabric, which wipe off deposits from cylinders. The nonwoven fabric for that use includes dry pulp nonwoven fabric, melt-blown nonwoven fabric, spun-bonded nonwoven fabric, and spun-laced nonwoven fabric. Especially for automatically cleaning offset printer cylinders, much used is spun-laced nonwoven fabric which is produced by entangling fibers of wood pulp, polyester or rayon through treatment with a water jet. The nonwoven fabric of the type has many advantages. For example, its appearance and feel are similar to those of cloth, it is strong and well absorbs liquid, and it is inexpensive. Therefore, the nonwoven fabric of the type is favorably used for cylinder cleaning sheets.

However, the current tendency in the art is toward high-speed printers, and it is much desired to further increase the efficiency of printers, or that is, to further shorten the setup time in printers. Spun-laced nonwoven fabric has a relatively smooth surface, and its friction to blanket cylinders to be cleaned with it is small, or that is, its ability to scrape deposits from cylinders is low. Therefore, it takes a lot of time for cleaning cylinders, and causes the difficulty in shortening the setup time in printers.

Another drawback of the cleaning sheet of spun-laced nonwoven fabric is that, when used for cleaning printer its fibrous composition and its production method. The fibrous leavings from the cleaning sheet remain on the surface of the cleaned blanket or deposit on the tail thereof, and they have some negative influences on prints. The fibrous leavings having adhered to the surface and the tail of the cleaned blanket have negative influences on the quality of prints, and therefore must be removed by hand washing by printing workers. Accordingly, there is another problem in that the hand-washing work is troublesome and takes a lot of time. In the current automatic printing operation, in addition, it is recognized that the hand-washing work is not only troublesome but also extremely dangerous since the worker must touch the rotor directly or via a waste, and there is a high risk that the worker's hand will be caught in or will get jammed in the rotor unit.

The cleaning sheet of spun-laced nonwoven fabric is produced by applying a high-pressure water jet to a sheet that is continuously prepared in a wet paper-making process, through a large number of nozzles. Therefore, the constituent fibers of the thus-produced sheet are apt to align in the machine direction, and, after the sheet has been treated with a water jet, a large number of grooves are formed in its surface running in the machine direction (MD). The cleaning sheet of spun-laced nonwoven fabric having the structure of that configuration is directional relative to the washing liquid sprayed thereon through a spray bar, and the washing liquid penetrates into the sheet along the machine direction. Therefore, the washing liquid could hardly spread in the sheet to wet it in the cross direction (CD), or that is, in the direction perpendicular to the machine direction (this is hereinafter referred to as cross direction). In addition, the water-jetted sheet has grooves in its surface, running parallel to each other in the machine direction. Owing to its configuration that has the grooves continuously running in the machine direction, the cleaning sheet contacts unevenly with cylinders, and therefore it is difficult to uniformly clean cylinders with the cleaning sheet.

In the cleaning sheet which could not be fully wetted in the cross direction, a washing liquid could not be uniformly spread in the cross direction when its amount jetted to the sheet is small. If the cleaning sheet thus unevenly wetted with such a small amount of washing liquid is used for cleaning blanket cylinders, the washing liquid supply to cylinders could not be unified. As a result, cylinders could not be well cleaned with the cleaning sheet. To solve the problem, if the amount of the washing liquid to be applied to the cleaning sheet is increased, the sheet could be well wetted in the cross direction. In that case, however, the amount of the washing liquid to be supplied to blankets is too much, and it will have some negative influences on the ability of the cleaning sheet to wipe off ink. In addition, the excess washing liquid and the washing liquid that contains the dissolved ink will drop off from the blanket surface and will reach printing plates.

If the washing liquid reaches printing plates in a printer in service, it will spread all over the rollers therein via the water-supply roller and the ink-supply roller that are contacted with printing plates in the printer. The washing liquid-containing ink lowers the preset print density. The water-supply roller must be hydrophilic by itself, but if it receives the oleophilic washing liquid, the hydrophilicity of the roller surface will be thereby lowered. If so, the washing liquid will have significant negative influences on the water-supply roller to such a degree that the roller could not ensure the best water supply condition.

The present invention has been developed for the purpose of solving the problems noted above. One important object of the invention is to provide a cleaning sheet of which the advantages are that it produces few fibrous leavings while in service in printers and ensures the smooth spread of washing liquid in the cross direction of the sheet and numerous irregularities of the sheet surface ensure the ability of the sheet to uniformly and completely clean printer cylinders, and to provide a method for producing the cleaning sheet.

The above and further objects and features of the invention will more fully be apparent from the following detailed description with accompanying drawings.

### SUMMARY OF THE INVENTION

The cleaning sheet of the invention for printer cylinders is produced by three-dimensionally aggregating fibers into a sheet in a wet paper-making process. The cleaning sheet contains thermofusible fibers serving as binder fibers, and its surface has numerous irregularities formed by creping the sheet at a temperature at which the thermofusible binder fibers constituting the sheet fuse.

Preferably, the cleaning sheet is produced by entangling the constituent fibers through treatment with a water jet. Also preferably, the aligning direction of the irregularities of the sheet surface formed through the water-jet treatment crosses that of the irregularities thereof formed through the creping treatment. The content of the thermofusible binder fibers in the sheet preferably falls between 5 and 50% by weight. If the content of the thermofusible binder fibers therein is too small, the fibrous leavings from the sheet will increase. On the contrary, if too small, the washing liquid retentivity of the sheet will lower and the cleaning ability thereof will also lower. Polyolefin fibers are preferred for the thermofusible binder fibers.

For producing the cleaning sheet for printer cylinders of the invention, fibers are three-dimensionally entangled in a wet paper-making process. In the method of producing the cleaning sheet, thermofusible fibers that serves as binder fibers are added to the constituent fibers of a sheet. In this, the sheet is creped at a temperature at which the thermofusible binder fibers fuse to thereby make the sheet surface have numerous irregularities.

The sheet may be creped on the side of the inlet of a drum drier, or may also be creped on the side of the outlet thereof. Preferably, the sheet is treated with a water jet to thereby make the constituent fibers entangled. Also preferably, the aligning direction of the irregularities of the sheet surface formed through the water-jet treatment crosses that of the irregularities thereof formed through the creping treatment.

Still preferably, the cleaning sheet of the invention is produced in a wet paper-making process using an inclined mesh screen paper-making machine or a mesh drum suction former.

The cleaning sheet of the invention mentioned above contain thermofusible fibers that serve as blinder fibers, and is creped by heating it at a temperature at which the thermofusible fibers therein fuse. Therefore, even when wetted with washing liquid applied thereto, the sheet does not lose its crepy configuration and realizes its stable and excellent cleaning ability, producing few fibrous leavings while in service in printers. In addition, since the cleaning sheet of the Invention is creped at a temperature at which the thermofusible binder fibers therein fuse, its mechanical strength increases and its resiliency increases, or that is, the cleaning sheet is toughened. This supports the characteristics that the cleaning sheet of the invention realizes its excellent cleaning ability and the work of exchanging the used cleaning sheet for a fresh one is easy.

In addition, since the thermofusible binder fibers in the sheet are fused to crepe the sheet and since the thus-creped sheet surface has irregularities running in the cross direction of the sheet, the aspect ratio MD/CD ratio) of fiber orientation in the sheet can be nearly 1/1 and the ability of the sheet to be wetted with washing liquid in the cross direction thereof is enhanced. Accordingly, when washing liquid is applied to the cleaning sheet, it can uniformly diffuse throughout the sheet in every direction, or that is, the direction in which the washing liquid diffuses in the sheet is not limited to the machine direction of the sheet. These excellent characteristics of the invention completely solve all the problems of cleaning work with conventional cleaning sheets. As described hereinabove, cleaning sheets significantly contribute toward improving the efficiency of recent high-speed printers, or that is, toward shortening the setup time in printers.

### BRIEF DESCRIPTION OF THE DRAWING

FIG. 1 is a plan view of a cleaning sheet of the invention.

### DETAILED DESCRIPTION OF THE INVENTION

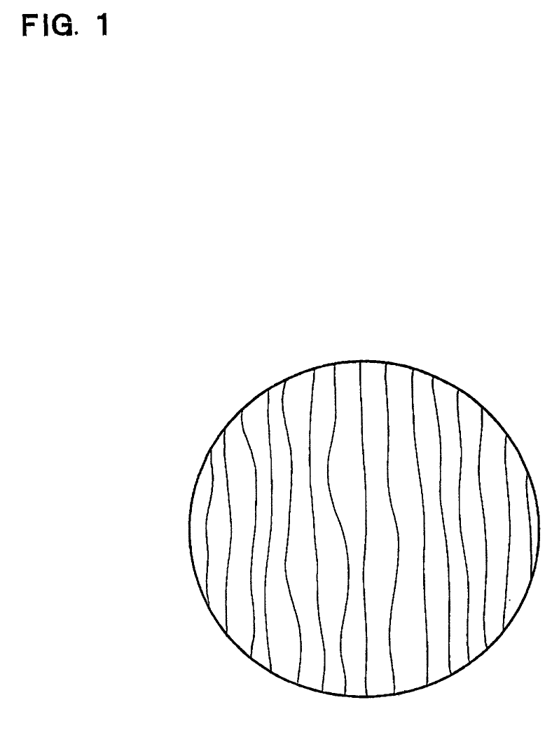

As in FIG. 1, the cleaning sheet for printer cylinders of the invention is formed of a mixture containing from 5 to 50% by weight of thermofusible binder fibers, and creped in the cross direction thereof at a temperature at which the thermofusible fibers therein fuse. When the content of the thermofusible binder fibers therein is defined to fall between 5 and 40 by weight, it ensures the best liquid retentivity of the cleaning sheet. As creped, the cleaning sheet can well wipe blanket cylinders. The cleaning sheet is fabricated by thermally creping a sheet produced in a wet paper-making process, and the thermofusible binder fibers therein are fused at their intersection points to thereby make the creped sheet surface have irregularities. Therefore, the cleaning sheet produces few fibrous leavings while in service in printers. In addition, the irregularities running in the cross direction of the creped sheet act to spread washing liquid applied thereto, in the cross direction of the sheet. Accordingly, the cleaning sheet can be entirely and uniformly wetted with washing liquid applied thereto. In addition, since the liquid retentivity of the cleaning sheet satisfies the necessary and sufficient condition for it, the sheet solves the problems of cleaning work with conventional cleaning sheets.

The invention is described concretely with reference to the following Examples, which, however, are not intended to restrict the scope of the invention. The physical properties of the samples produced in the Examples were measured in the manner mentioned below. Unless otherwise specifically indicated, “%” are all by weight.

Weight:

Measured according to JIS P 8124.

Thickness:

Measured according to JIS P 8118.

Tensile Strength:

Measured according to JIS P 8113.

Wet Tensile Strength:

Measured according to JIS P 8115.

Water Absorption:

Measured according to JIS P 8141.

Water Content:

To measure this, the inventors planned an original method, which is as follows:

An absolutely dried sample of 10 cm×20 cm square is dipped in water for 6 to 10 seconds, and lightly wiped with an absorbent sheet. The water content of the sample is obtained according to the following formula:

Water Content (%)=[(B−A)+A]×100]

A: weight (g) before dipped,

B: weight (g) after dipped.

Surface Strength:

Measured according to TAPPI T 459.

Aspect Ratio:

This Is the ratio of the tensile strength in MD to that in CD measured as above, for which the CD tensile strength is 1.

Aspect Ratio=MD tensile strength+CD tensile strength:1 (CD tensile strength ratio).

### EXAMPLE 1

Fibers <1> to <4> mentioned below were mixed, and a wet paper strength enhancer and a fixer were added to the resulting mixture to prepare a pulp slurry. The pulp slurry was sheeted into a cleaning sheet in a wet paper-making process. The wet paper strength enhancer used is polyamidepichlorohydrin. Its amount added is 2% by weight of the fiber mixture. The fixer used is aluminium sulfate. Its amount added is 1% by weight of the fiber mixture.

<1> Binder fibers 5%

This is PVA binder fibers having a fineness of 1.1 dtex and a length of 3 mm.

<2> Polyester fibers 10%

This has a fineness of 1.5 dtex and a length of 5 mm.

<3> Hemp pulp 20%

<4> Bleached softwood kraft pulp 65

The above fibers were mixed, and the resulting pulp slurry having a final concentration of 0.07% was sheeted, using an inclined mesh screen paper-making machine. In the paper-making process, the wet paper running on the mesh screen was treated with a water jet to thereby make the constituent fibers entangled, and then this was creped in the cross direction in the wet zone before the inlet of a drum drier, Yankee drier. The Yankee drier was controlled to have a surface temperature of 100° C.

### EXAMPLE 2

Fibers <1> to <4> mentioned below were mixed, and a wet paper strength enhancer and a fixer were added to the resulting mixture to prepare a pulp slurry. The pulp slurry was sheeted into a cleaning sheet In a wet paper-making process. The wet paper strength enhancer used is melamine resin. Its amount added is 2% by weight of the fiber mixture. The fixer used is aluminium sulfate. Its amount added is 1% by weight of the fiber mixture.

<1> Binder fibers 5%

This is PVA binder fibers having a fineness of 1.1 dtex and a length of 3 mm.

<2> Rayon fibers 10%

This has a fineness of 0.8 dtex and a length of 7 mm.

<3> Hemp pulp 20

<4> Bleached softwood craft pulp 65

The above fibers were mixed, and the resulting pulp slurry having a final concentration of 0.07 was sheeted, using an inclined mesh screen paper-making machine. In the paper-making process, the wet paper running on the mesh screen was treated with a water jet to thereby make the constituent fibers entangled, and then this was creped in the cross direction in the wet zone before the inlet of a drum drier, Yankee drier. The Yankee drier was controlled to have a surface temperature of 100° C.

### EXAMPLE 3

Fibers <1> to <3> mentioned below were mixed, and the resulting fiber mixture was dispersed in water to prepare a pulp slurry. The pulp slurry was sheeted into a cleaning sheet in a wet paper-making process.

<1> Binder fibers 1, 25%

This is core/sheath polyolefin fibers having a fineness of 2.2 dtex and a length of 10 mm, in which the core is polypropylene and the sheath is polyethylene.

<2> Binder fibers 2, 5%

This is PVA binder fibers having a fineness of 1.1 dtex and a length of 3 mm.

<3> Bleached softwood kraft pulp 70%

The above fibers were mixed, and the resulting pulp slurry having a final concentration of 0.07% was sheeted, using an inclined mesh screen paper-making machine. In the paper-making process, the wet paper running on the mesh screen was treated with a water jet to thereby make the constituent fibers entangled, and then this was creped in the cross direction in the wet zone before the inlet of a drum drier, Yankee drier. The Yankee drier was controlled to have a surface temperature of 135° C.

### EXAMPLE 4

Fibers <1> to <3> mentioned below were mixed, and a wet paper strength enhancer and a fixer were added to the resulting mixture to prepare a pulp slurry. The pulp slurry was sheeted into a cleaning sheet in a wet paper-making process. The wet paper strength enhancer used is polyamidepichlorohydrin. Its amount added is 1% by weight of the fiber mixture. The fixer used is aluminium sulfate. Its amount added is 1% by weight of the fiber mixture.

<1> Binder fibers 1, 35%

This is core/sheath polyolefin fibers having a fineness of 2.2 dtex and a length of 10 mm, in which the core is polypropylene and the sheath is polyethylene.

<2> Binder fibers 2, 5%

This is PVA binder fibers having a fineness of 1.1 dtex and a length of 3 mm.

<3> Bleached softwood kraft pulp 60%

The above fibers were mixed, and the resulting pulp slurry having a final concentration of 0.07 was sheeted, using an inclined mesh screen paper-making machine. In the paper-making process, the wet paper running on the mesh screen was treated with a water jet to thereby make the constituent fibers entangled, and then this was creped in the cross direction in the dry zone after the outlet of a drum drier, Yankee drier. The Yankee drier was controlled to have a surface temperature of 130° C.

### EXAMPLE 5

Fibers <1> to <4> mentioned below were mixed, and the resulting fiber mixture was sheeted into a cleaning sheet in a wet paper-making process.

<1> Binder fibers 1, 35

This is core/sheath polyolefin fibers having a fineness of 2.2 dtex and a length of 10 mm, in which the core is polypropylene and the sheath is polyethylene.

<2> Binder fibers 2, 5

This is PVA binder fibers having a fineness of 1.1 dtex and a length of 3 mm.

<3> Hemp pulp 10%

<4> Bleached softwood kraft pulp 50

The above fibers were mixed, and the resulting pulp slurry having a final concentration of 0.07% was sheeted, using an inclined mesh screen paper-making machine. In the paper-making process, the wet paper running on the mesh screen was treated with a water Jet to thereby make the constituent fibers entangled, and then this was creped in the cross direction in the dry zone after the outlet of a drum drier, Yankee drier. The Yankee drier was controlled to have a surface temperature of 130° C.

### EXAMPLE 6

Fibers <1> to <3> mentioned below were mixed, and a wet paper strength enhancer and a fixer were added to the resulting mixture to prepare a pulp slurry. The pulp slurry was sheeted into a cleaning sheet in a wet paper-making process. The wet paper strength enhancer used is melamine resin. Its amount added is 1% by weight of the fiber mixture. The fixer used is aluminium sulfate. Its amount added is 1% by weight of the fiber mixture.

<1> Binder fibers 1, 30%

This is core/sheath polyolefin fibers having a fineness of 1.7 dtex and a length of 10 mm, in which the core is polypropylene and the sheath is polyethylene.

<2> Binder fibers 2, 5

This is PVA binder fibers having a fineness of 1.1 dtex and a length of 3 mm.

<3> Bleached softwood kraft pulp 65

The above fibers were mixed, and the resulting pulp slurry having a final concentration of 0.07 was sheeted, using an inclined mesh screen paper-making machine. In the paper-making process, the wet paper running on the mesh screen was treated with a water jet to thereby make the constituent fibers entangled, and then this was creped in the cross direction in the dry zone after the outlet of a drum drier, Yankee drier. The Yankee drier was controlled to have a surface temperature of 132° C.

Having received a water jet in their production process, the cleaning sheets produced in Examples 1 to 6 have surface irregularities running in the machine direction of the sheet, and the irregularities of the surface of each sheet formed through the creping treatment run in the cross direction. Accordingly, the aligning direction of the surface irregularities formed through the water-Jet treatment perpendicularly crosses that of the surface irregularities formed through the creping treatment. The water jet to be applied to the sheets may be inclined relative to the machine direction, and in that case, the aligning direction of the surface irregularities formed through the water-jet treatment obliquely crosses that of the surface irregularities formed through the creping treatment.

The desired values of the physical properties of the cleaning sheets produced in the Examples are shown in Table 1 below.

The physical properties of the cleaning sheets produced in the Examples and those of a conventional cleaning sheet of spun-laced nonwoven fabric are shown in Table 2 and Table 4, and the test results of the cleaning sheets are shown in Table 3 and Table 5.

TABLE 1

| | | Desired Values of | |
|---|---|---|---|
| Items | | Physical Properties | Test Methods |
| Weight | g/m² | 72 ± 5 | JIS P8124 |
| Thickness | mm | 0.280 ± 0.030 | JIS P8118 |
| Density | g/mm³ | 0.260 ± 0.030 | JIS P8118 |
| Tensile Strength | | | |
| MD | kg/10 mm | 1.5< | JIS P8113 |
| CD | | 0.8< | |
| Wet Tensile Strength | kg/10 mm | 0.8< | JIS P8135 |
| MD | | | |
| Water Absorption | mm/min | 30< | JIS P8141 |
| MD | | | |
| Water Content | % | 150< | |
| Surface Strength | No. | 12< | TAPPI T459 |

TABLE 2

| | | | | | Conventional |
|---|---|---|---|---|---|
| | | Example 1 | Example 2 | Example 3 | Sheet |
| Weight | g/m² | 72.9 | 69.0 | 74.0 | 60.0 |
| Thickness | mm | 0.216 | 0.181 | 0.301 | 0.211 |
| Density | g/cm³ | 0.334 | 0.378 | 0.246 | 0.282 |
| Tensile | kg/10 mm | 1.74 | 3.29 | 2.22 | 3.02 |
| Strength | | | | | |
| MD | | | | | |
| Tensile | kg/10 mm | 1.12 | 1.91 | 1.12 | 0.52 |
| Strength | | | | | |
| CD | | | | | |
| Wet | kg/10 mm | 0.73 | 1.41 | 0.82 | 2.89 |
| Tensile | | | | | |
| Strength | | | | | |
| MD | | | | | |
| Water | mm/min | 35 | 22 | 27 | 51 |
| Absorp- | | | | | |
| tion | | | | | |
| MD | | | | | |
| Water | % | 149 | 118 | 138 | 1.61 |
| Content | | | | | |
| Surface | Picking | 12 | 18 | 16 | 8 |
| Strength | No. | | | | |
| Aspect | | 1.6/1 | 1.7/1 | 2.0/1 | 5.8/1 |
| Ratio | | | | | |
| (MD/CD) | | | | | |

TABLE 3

| | | | | Conventional |
|---|---|---|---|---|
| | Example 1 | Example 2 | Example 3 | Sheet |
| Ink Cleaning | ◯◯ | ◯◯ | ◯◯ | ◯ |
| Paper Powder | ◯◯ | ◯◯ | ◯◯ | ◯ |
| Cleaning | | | | |
| Fiber Leavings | ◯◯ | ◯◯ | ◯◯ | X |
| Sheet Breakage | ◯ | ◯ | ◯ | ◯ |
| Liquid Dripping | ◯ | ◯ | ◯ | ◯ |
| (liquid absorption) | | | | |

TABLE 4

| | | Example 4 | Example 5 | Example 6 |
|---|---|---|---|---|
| Weight | g/m² | 69.0 | 73.5 | 69.9 |
| Thickness | mm | 0.284 | 0.263 | 0.263 |
| Density | g/cm³ | 0.243 | 0.279 | 0.266 |
| Tensile Strength | kg/10 mm | 2.01 | 2.03 | 1.87 |
| MD | | | | |
| Tensile Strength | kg/10 mm | 0.96 | 1.00 | 0.96 |
| CD | | | | |
| Wet Tensile Strength | kg/10 mm | 0.90 | 0.90 | 0.95 |
| MD | | | | |
| Water Absorption | mm/min | 30 | 31 | 31 |
| MD | | | | |
| Water Content | % | 155 | 163 | 180 |
| Surface Strength | Picking | 14 | 14 | 13 |
| | No. | | | |
| Aspect Ratio | | 2.1/1 | 2.0/1 | 1.9/1 |
| (MD/CD) | | | | |

TABLE 5

| | Example 4 | Example 5 | Example 6 |
|---|---|---|---|
| Ink Cleaning | ◯◯ | ◯◯ | ◯◯ |
| Paper Powder Cleaning | ◯◯ | ◯◯ | ◯◯ |
| Fiber Leavings | ◯◯ | ◯◯ | ◯◯ |
| Sheet Breakage | ◯ | ◯ | ◯ |
| Liquid Dripping | ◯ | ◯ | ◯ |
| (liquid absorption) | | | |

The wet strength and the surface strength of the cleaning sheets of Examples 1 and 2 are both high. While in service the sheets did nnt break and produced few fiber leavings. The wet strength of the cleaning sheet of Example 3 is good. While in service, the sheet did not break, and its ability to scrape

ink and other deposits was good.

The surface strength of the cleaning sheets of Examples 4, 5 and 6 is high. Therefore, the sheets produced few fiber leavings while in service, and their cleaning capabilities were all good. The sheets are practicable for cleaning printer cylinders.

The surface strength of the conventional cleaning sheet of spun-laced nonwoven fabric is low. Therefore, the sheet produced many fiber leavings while in service, and it significantly worsened the working efficiency of printers.

In their production process, the cleaning sheets of Examples 1 and 2 were heated in the wet zone before the inlet of the Yankee drier to thereby fuse the constituent fibers at their intersection points; and the cleaning sheets of Examples 3 and 4 were heated in the wet or dry zone before or after the inlet or the outlet of the Yankee drier to thereby fuse the polyolefin binder fibers in the sheets. Therefore, when wetted, these sheets still kept their crepy configuration not losing it, and while in service for cleaning printer cylinders, they produced few fiber leavings and their ability to clean printer cylinders was stable and good. In particular, the crepy configuration retentiveness of the cleaning sheets of Examples 4 to 6 is extremely good, and their ability to scrape deposits from printer cylinders is extremely good.

Since the cleaning sheets of Examples 1 to 6 were produced by the use of an inclined mesh screen paper-making machine, the fibers constituting them were uniformly oriented both in the machine direction and the cross direction. Therefore, the aspect ratio, MD/CD of these sheets falls between 1.6/1 and 2.1/1, or that is, the MD value thereof falling between 1.6 and 2.1 is near to the CD value thereof of 1. This means that the sheets solve the problem with conventional spun-laced nonwoven fabric which hardly allows the spread of washing liquid in the cross direction. Accordingly, the cleaning sheets of the invention produced by the use of an inclined mesh screen paper-making machine enables uniform omnidirectional dispersion of washing liquid therein. Not limited to those, the cleaning sheet of the invention can also be produced in a wet paper-making process of using a mesh drum suction former. In the cleaning sheets produced by the use of a mesh drum suction former, the constituent fibers are also uniformly oriented in both the machine direction and the cross direction. Therefore, the cleaning sheets produced in the method of using a mesh drum suction former also allow rapid diffusion of washing liquid in them in the cross direction.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within meets and bounds of the claims, or equivalence of such meets and bounds thereof are therefore intended to be embraced by the claims.

1. A cleaning sheet for printer cylinders, which is produced by three-dimensionally aggregating fibers into a sheet in a wet paper-making process, and which is characterized in that;
the fibers constituting the sheet contain thermofusible fibers that serve as binder fibers, and the sheet is creped at a temperature at which the thermofusible binder fibers fuse to thereby make the sheet surface have numerous irregularities.

2. The cleaning sheet for printer cylinders as claimed in claim 1, which is treated with a water jet to thereby make the constituent fibers entangled.

3. The cleaning sheet for printer cylinders as claimed in claim 1, wherein the aligning direction of the surface irregularities formed through the water-jet treatment crosses that of the surface irregularities formed through the creping treatment.

4. The cleaning sheet for printer cylinders as claimed in claim 1, wherein the content of the thermofusible binder fibers falls between 5 and 50% by weight.

5. The cleaning sheet for printer cylinders as claimed in claim 4, wherein the content of the thermofusible binder fibers falls between 5 and 40% by weight.

6. The cleaning sheet for printer cylinders as claimed in claim 1, wherein the thermofusible binder fibers are any or both of polyolefin fibers and PVA binder fibers.

7. A method for producing a cleaning sheet for printer cylinders, which comprises three-dimensionally aggregating fibers into a sheet in a wet paper-making process, and which is characterized in that;
the fibers to constitute the cleaning sheet are mixed with thermofusible binder fibers added thereto, and the sheet formed of the mixed fibers is creped by heating it at a temperature at which the thermofusible binder fibers fuse to thereby make the creped sheet surface have numerous irregularities.

8. The method for producing a cleaning sheet for printer cylinders as claimed in claim 7, wherein the wet sheet formed is creped before the inlet of the drum drier that acts to dry the sheet.

9. The method for producing a cleaning sheet for printer cylinders as claimed in claim 8, wherein the wet sheet formed is creped in the wet zone before the inlet of the drum drier.

10. The method for producing a cleaning sheet for printer cylinders as claimed in claim 7, wherein the wet sheet formed is creped after the outlet of the drum.

11. The method for producing a cleaning sheet for printer cylinders as claimed in claim 10, wherein the sheet is creped in the dry zone after the outlet of the drum drier.

12. The method for producing a cleaning sheet for printer cylinders as claimed in claim 7, wherein the drum drier to act the wet sheet formed is a Yankee drier.

13. The method for producing a cleaning sheet for printer cylinders as claimed in claim 12, wherein the surface temperature of the Yankee drier falls between 100° C. and 135° C.

14. The method for producing a cleaning sheet for printer cylinders as claimed in claim 7, wherein the sheet having been treated with a water jet to make the constituent fibers entangled is creped.

15. The method for producing a cleaning sheet for printer cylinders as claimed in claim 7, wherein the aligning direction of the surface irregularities formed through the water-jet treatment crosses that of the surface irregularities formed through the creping treatment.

16. The method for producing a cleaning sheet for printer cylinders as claimed in claim 7, wherein the content of the thermofusible fibers in the sheet falls between 5 and 50% by weight.

17. The method for producing a cleaning sheet for printer cylinders as claimed in claim 7, wherein the content of the thermofusible fibers in the sheet falls between 5 and 40% by weight.

18. The method for producing a cleaning sheet for printer cylinders as claimed in claim 7, wherein the sheet is formed by the use of an inclined mesh screen paper-making machine or a mesh drum suction former in a wet paper-making process.
